(19) United States
(12) Patent Application Publication
(10) Pub. No.: US 2009/0241366 A1
(43) Pub. Date: Oct. 1, 2009

(54) Laundry treating machine and controlling method of the same

(76) Inventors: Dae Yun Park, Seoul (KR); Dong Won Kim, Seoul (KR); Jong Seok Kim, Seoul (KR); Sog Kie Hong, Seoul (KR); Hea Kyung Yoo, Seoul (KR)

Correspondence Address: MCKENNA LONG & ALDRIDGE LLP, 1900 K STREET, NW, WASHINGTON, DC, 20006, US

(21) Appl. No.: 12/383,000

(22) Filed: Mar. 27, 2009

(30) Foreign Application Priority Data
Apr. 1, 2008 (KR) 10-2008-0030333

(51) Int. Cl. F26B 3/02; F26B 19/00; F26B 25/08

(52) U.S. Cl. 34/467; 34/60; 34/218

(57) ABSTRACT

A laundry treating machine and a control method of the same are disclosed. The present invention relates to a laundry treating machine capable of efficiently treating clothes received therein. The laundry treating machine includes an accommodating space receiving laundry therein, a circulation duct in communication with the accommodating space, a first condensing device provided along the circulation duct and supplying dried air to the accommodating space and a second condensing device provided along the circulation duct and increasing dryness of air supplied to the accommodating space, independent from the first condensing device.

### CROSS REFERENCE TO RELATED APPLICATION

This application claims the benefit of the Korean Patent Application No. 10-2008-0030333, filed on Apr. 1, 2008, which is hereby incorporated by reference as if fully set forth herein.

### BACKGROUND OF THE DISCLOSURE

1. Field of the Disclosure

The present disclosure relates to a laundry treating machine. More particularly, the present disclosure relates to a laundry treating machine capable of treating clothes received therein efficiently.

2. Discussion of the Related Art

Laundry treating machines typically include washing machines, dryers, laundry machines having washing and drying functions and refreshers. Dryers, some laundry machines having washing and drying functions, and some refreshers are capable of removing moisture from clothing or other cloth items (hereinafter, laundry) by using dried and or heated air supplied directly to the laundry.

The laundry treating machines capable of supplying dried air to the laundry generally uses a fan or blower to circulate the dry air and remove the moisture from the clothing. However, conventional fans are rotated at high speeds thus generate severe noise, which may be bothersome or unpleasant to a user.

The embodiments described herein solve the above disadvantage of the conventional laundry treating machine and a laundry treating machine is provided capable of removing moisture from laundry received therein, with reduced noise production.

### SUMMARY OF THE DISCLOSURE

Accordingly, the present invention is directed to a laundry treating machine and a control method of the same.

Additional advantages and features of the disclosure will be set forth in part in the description which follows and in part will become apparent to those having ordinary skill in the art upon examination of the following or may be learned from practice of the invention. The advantages and features of the invention may be realized and attained by the structure particularly pointed out in the written description and claims hereof as well as the appended drawings.

To achieve these and other advantages and in accordance with the purpose of the invention, as embodied and broadly described herein, a laundry treating machine includes an accommodating space receiving laundry therein; a circulation duct in communication with the accommodating space; a first condensing device provided along the circulation duct and supplying dried air to the accommodating space; and a second condensing device provided along the circulation duct and increasing dryness of air supplied to the accommodating space, independent from the first condensing device. Here, the first condensing device may be configured of a heat pump.

The laundry treating machine may further include a fan blowing air along the circulation duct. The second condensing device may be configured of a heat exchanging unit exchanging heat with air supplied to the accommodating space. For example, the heat exchanging unit may be at least one fin.

The heat exchanging unit may include a first heat exchanger provided at an outside of the circulation duct. The heat exchanging unit may further include at least one of a second heat exchanger provided at an inside of the circulation duct and a cooler cooling the first heat exchanger. In this case, the cooler may be configured of a cooling fan.

The laundry treating machine may further include a steam generator supplying steam to the accommodating space.

In another aspect, a control method of a laundry treating machine including a first condensing device supplying dried air to an accommodating space receiving laundry therein and a second condensing device increasing dryness of air, independent from the first condensing device, includes selecting a driving mode of the laundry treating machine, the mode comprising a first and second mode; and controlling the first condensing device and the second condensing device according to the selected mode, wherein the first condensing device is driven if the first mode is selected and the second condensing device is driven if the second mode is selected.

The control method may further include controlling a fan to blow the dried air if the first condensing device or the second condensing device is driven. Here, the fan may be driven at a half of a rotation number of the first mode or lower if the second mode is selected. The mode of the laundry treating machine may further include a third mode and the fan and the first and second condensing devices are driven if the third mode is selected. The control method may further include driving a cooler cooling the second condensing device if the second condensing device is driven.

The first condensing device may include a heat pump including an evaporator, a compressor, and a condenser. The laundry treating machine may further include a circulation fan cooling the compressor. In this case, the control method further includes driving the circulation fan if the second condensing device is driven.

In a further aspect, a laundry treating machine includes an accommodating space receiving laundry therein; a circulation duct in communication with the accommodating space; a condensing device provided along the circulation duct and supplying dried air to the accommodating space; and a heater provided along the circulation duct and heating air supplied to the accommodating space to increase dryness of air, independent from the first condensing device. The heater may be provided adjacent to an outlet through which dried air is supplied from the circulation duct to the accommodating space.

In a still further aspect, a control method of a laundry treating machine including a condensing device supplying dried air to an accommodating space receiving laundry therein and a heater heating air, independent from the first condensing device, includes selecting a driving mode of the laundry treating machine, the mode comprising a first mode and second mode; and controlling the condensing device and the heater according to the selected mode, wherein the condensing device is driven if the first mode is selected and the heater is driven if the second mode is selected. The control method may further include driving a fan to blow the dried air when the condensing device or the heater is driven. The fan may be driven at a half of a rotation speed of the first mode if the second mode is selected. The mode of the laundry treating machine may further include a third mode, wherein the fan, the condensing device, and the heater are driven if the third mode is selected.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a front view illustrating a laundry treating machine according to an exemplary embodiment of the present invention;

FIG. 2 is a perspective view schematically illustrating an inner configuration of a mechanism compartment shown in FIG. 1;

FIG. 3 is a sectional view partially illustrating an embodiment of a second condensing device according to an embodiment of the invention;

FIG. 4 is sectional view partially illustrating another embodiment of the second condensing device according to an embodiment of the invention;

FIG. 5 is flow chart illustrating a control method of the laundry treating machine according to an exemplary embodiment of the present invention; and

FIG. 6 is a diagram schematically illustrating a configuration of a laundry treating machine according to another embodiment of the present invention.

### DESCRIPTION OF THE EMBODIMENTS

Reference will now be made in detail to embodiments of the present invention, examples of which are illustrated in the accompanying drawings. Wherever possible, the same reference numbers will be used throughout the drawings to refer to the same or like parts.

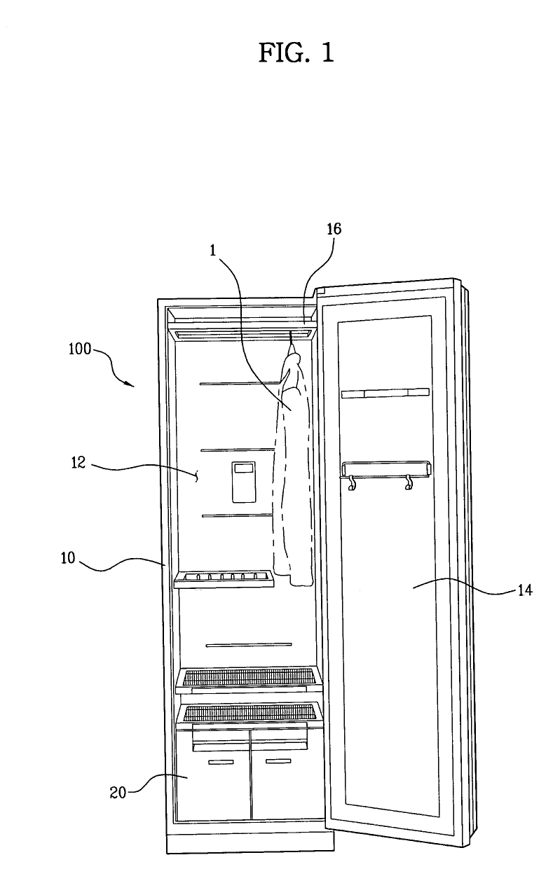

FIG. 1 is a front view illustrating a laundry treating machine according to an exemplary embodiment of the present invention.

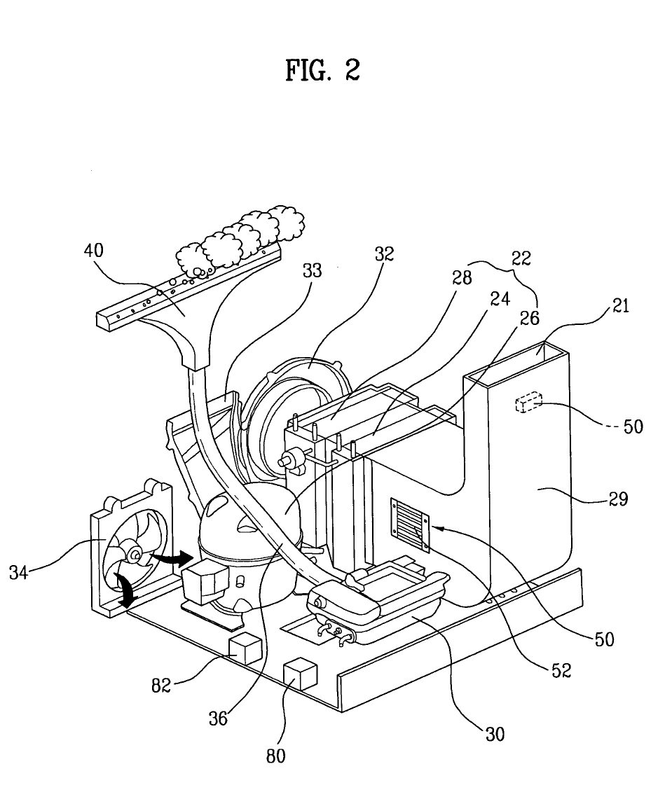

As illustrated in FIG. 1, the laundry treating machine according to the exemplary embodiment includes an accommodating space 12, a first condensing device 22 (FIG. 2) and a second condensing device 50 (FIG. 2). The accommodating space 12 receives laundry. The first condensing device 22 supplies dried air to the accommodating space 12. The second condensing device 50 works independently from the first condensing device 22 and acts to increases the dryness of the air dried at the first condensing device 22.

The accommodating space 12 is formed within a cabinet 10, which defines an exterior appearance of the laundry treating machine 100. A door 14 is provided to allow a user to selectively open or close the accommodating space during use. Various support structures such as a rack 16 may be provided inside the accommodating space 12 to support hanging laundry 1 or laundry placed on the rack. The general configuration for supporting the laundry 1 is known in the art to which the present invention pertains, thus the detailed description thereof will be omitted.

A mechanism compartment 20 may be formed in the cabinet 10 and may comprise the first condensing device 22 and the second condensing device 50. The mechanism compartment 20 is preferably provided under the accommodating space 12 and the first and second condensing devices 22 and 50 are positioned inside the mechanism compartment 20. This position is preferable, because the dried air supplied thereto is generally a high temperature and therefore has the natural tendency to ascend.

FIG. 2 is a perspective view schematically illustrating an inner configuration of the mechanism compartment 20 shown in FIG. 1.

As illustrated in FIG. 2, the mechanism compartment 20 includes the first condensing device 22 for supplying dried air to the accommodating space 12 (FIG. 1) and the second condensing device 50 for enhancing the dryness of the dried air, independent from the first condensing device 22.

In the exemplary embodiment, the first condensing device 22 may be a heat pump substantially similar to those used in air conditioners. Thus the heat pump may include an evaporator 24, a compressor 26, a condenser 28, and an expansion valve (not shown), through which refrigerant is circulated sequentially to dehumidify and heat air. The evaporator 24 and the condenser 28 act as a heat-exchanger, such that the air circulated to the mechanism compartment 20 may first be cooled and dehumidified and then heated before it is fed back into the accommodating space 12.

Specifically, the air may first enter the evaporator 24. The evaporator 24 evaporates the refrigerant flowing through it and the refrigerant absorbs latent heat from the ambient air, thus cooling the air and condensing the moisture contained therein. Then the air passes through the condenser 28. The refrigerant flowing from the compressor 26 into the condenser 28 is condensed and releases latent heat into the ambient air passing through the condenser, thus heating the ambient air. The dried, heated air is then re-supplied to the accommodating space 12 once it has passed the evaporator 24 and the condenser 28.

The temperature of the air heated by the heat pump 22 may be relatively lower than air heated by a conventional electric heater. However, with the heat pump the air can also be dehumidified without the need for an auxiliary dehumidifier. It is noted that the term “relatively low temperature” means heated air having a temperature lower when compared with, or relevant to, air heated by a conventional heater, however, the air does not necessarily have a substantially low temperature. While the heated air may be at a relatively low temperature, the air is dehumidified without the need for an additional dehumidifying unit and, as a result, the laundry may be dried and refreshed easily without complications.

An inlet 21 formed on a circulation duct 29 may be disposed at a top of the mechanism compartment 20 and air inside the accommodating space 12 may be drawn into the inlet 21. The circulation duct 29 connects the evaporator 24, the condenser 28, and a fan 32, and defines an air circulation flow path. The air following the circulation flow path may be drawn into the inlet 21, from the accommodating space, and may pass into the circulation duct 29. The air may then be dehumidified and heated as it passes the heat pump 22, and then may be re-supplied to the accommodating space 12 via an outlet 33 by a fan 32.

Although not shown, a filter may be provided at the inlet 21. The filter provided at the inlet 21 may filter various foreign substances, such as lint, hair, or the like, which might be contained in the air supplied from the accommodating space. Thus, allowing only filtered air to be supplied to the circulation duct 29 and re-supplied to the accommodating space 12.

As mentioned above, the laundry treating machine according to this embodiment may include a second condensing device 50 operating separately and independently from the first condensing device 22. Among the elements in the heat pump 22, the compressor 26 may tend to generate a substantial amount of noise. To eliminate this noise the heat pump 22 may be stopped and the moisture of the air may then be removed by the second condensing device 50. The second condensing device may be capable of generating substantially less noise than the heat pump, while still supplying dried air to the accommodating space 12.

The second condensing device 50 may be provided in the mechanism compartment 20. It is preferable that the second condensing device 50 is provided along the circulation duct 29 defining the air circulation flow path. In addition, the second condensing device 50 may be configured as a heat exchanging unit that generates less noise than the heat pump. For example, the second condensing device 50 may be a first heat exchanger 52 including at least one fin or a plurality of fins, as shown in FIG. 2. The fins 52 may be provided along an outside of the circulation duct 29, promoting the heat exchange between external air and internal air of the circulation duct 29 to increase the dryness of the internal air.

Specifically, if steam is supplied to the accommodating space 12 by a steam generator 30, which will be described later, the air drawn into the circulation duct 29 may have a somewhat high temperature. The higher temperature air inside the circulation duct 29, the internal air, may heat-exchange with relatively cool air outside the circulation duct 29. The temperature of the internal air is thus lowered and the moisture contained in the air condenses. Accordingly, the humidity of the air is thus reduced.

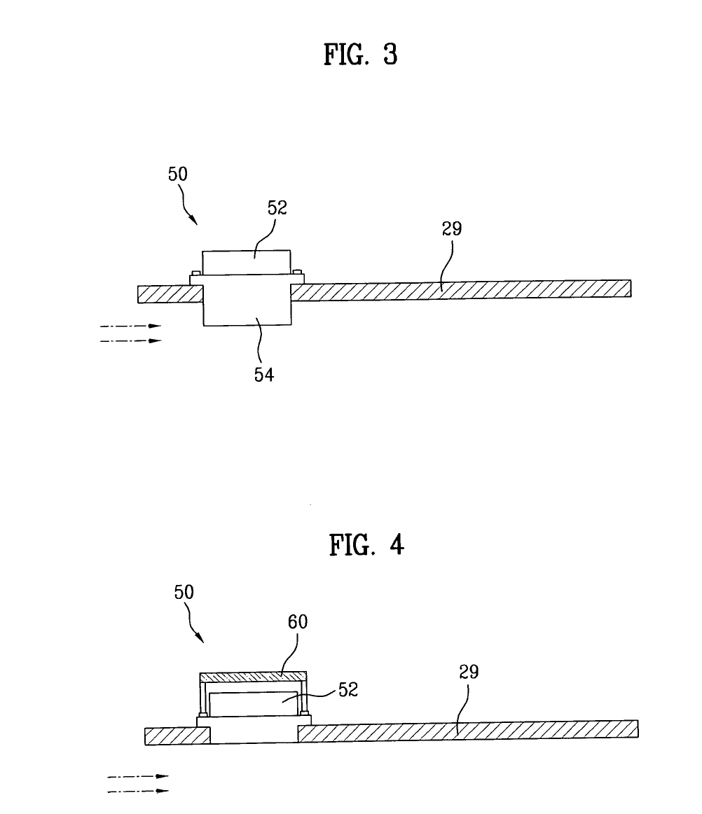

The second condensing device 50 may be configured in various ways. FIGS. 3 and 4 are sectional views illustrating various examples of the second condensing device, respectively.

FIG. 3 is a sectional view partially illustrating an embodiment of the second condensing device according to an embodiment of the invention.

As illustrated in FIG. 3, the second condensing device 50 may further include a second heat exchanger 54, corresponding to the first heat exchanger 52, and provided along an inside of the circulation duct 29. The second heat exchanger 54 may be configured of at least one fin or a plurality of fins, like the first heat exchanger 52. Heat exchangers 52 and 54 may be provided along the inside and outside of the circulation duct, respectively, to promote the heat exchange between the internal and external air of the circulation duct. As a result, the moisture contained in the air passing along the circulation duct 29 (represented by arrows in FIG. 3) may be removed efficiently.

FIG. 3 shows that the first and second heat exchangers 52 and 54 may be positioned in a symmetrical manner about a wall of the circulation duct 29; however, they are not limited to this positioning. That is, the first and second heat exchangers 52 and 54 may be provided at different corresponding positions along the circulation duct.

FIG. 4 is a sectional view partially illustrating another embodiment of the second condensing device 50 according to an embodiment of the invention.

As illustrated in FIG. 4, the second condensing device 50 may further include a cooler 60, which is configured to cool the first heat exchanger 52. The cooler 60 cools the first heat exchanger 52 so that the heat exchanging performed at the first heat exchanger 52 may be accomplished more efficiently. The cooler 60 may be realized by a variety of devices. In the present exemplary embodiment, as shown in FIG. 4, the cooler may be provided as a cooling fan 60 to cool the first heat exchanger 52.

According to the exemplary embodiments of FIGS. 3 and 4, the second condensing device 50 may include either the second heat exchanger 54 or the cooler 60, together with the first heat exchanger 52. The second condensing device 50 according to the present invention is not limited to this arrangement. For example, the second condensing device 50 may include all of the first heat exchanger 52, the second heat exchanger 54, and the cooler 60.

A steam generator 30 may also be provided in the mechanism compartment 20 to supply steam to the accommodating space 12. The introduction of a steam spray acts to remove wrinkles and odors, which may be present in the laundry to be treated. The high temperature of steam may also act to sanitize the fabric of the laundry, thus providing a refreshing effect on the laundry. The timing of the steam introduction may vary depending on the operating cycle chosen by the user. For example, it may be preferable that steam is sprayed prior to the introduction of the dried air by the first condensing device 22, so that the steamed laundry can dry before the cycle ends.

The steam generator 30 may include a heater (not shown) to heat the water contained inside and generate steam. The generated steam may then be supplied to the accommodating space 12. A water supply source for supplying water to the steam generator 30 may be an external water tap or a stand-alone container type supply provided in the mechanism compartment 20. The container type water supply source may also be removable from the mechanism compartment 20. Thus, the user may separate the container from the mechanism compartment 20 to fill it up and reinstall it, thus replenishing the steam generator water supply source.

The steam generated by the steam generator 30 may be supplied to the accommodating space 12 via a steam hose 36 and a steam nozzle 40. It is preferable to have a shorter steam hose 36 to prevent the steam passing along the steam hose 36 from decreasing in temperature. If the mechanism compartment 20 is provided under the accommodating space 12, the steam nozzle 40 may supply steam from a top of the mechanism compartment 20, which is also a bottom of the accommodating space 12.

In addition, a circulation fan 34 may be provided in a rear of the mechanism compartment 20. The circulation fan 34 blows external air into the mechanism compartment 20 to cool the heat pump 22, specifically the compressor 26 of the heat pump 22. This cooling effect serves to prevent the temperature inside the mechanism compartment 20 from rising to undesirable levels.

Next, a control method of the laundry treating machine having the above configuration will be described as illustrated in the corresponding drawings.

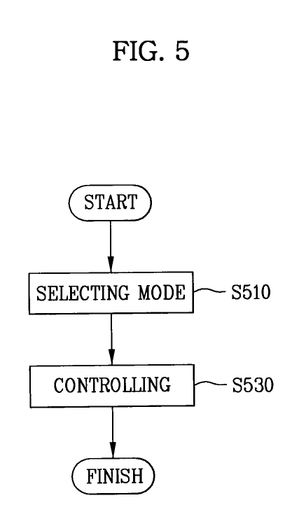

As illustrated in FIG. 5, the control method of the laundry treating machine, according to an exemplary embodiment of the present invention, includes selecting a mode of the laundry treating machine (S510) and controlling operations of the first condensing device 22, the second condensing device 50, and the fan 32 in accordance with the selected mode. (S530).

The user loads the laundry into the laundry treating machine and then selects a mode of the laundry treating machine (S510). Here, at least one mode or a plurality of modes may be provided in the laundry treating machine. For example, three modes including a first, second, and third mode. The first mode may be a normal mode. The second mode may be a silent mode or night mode, which functions generating little noise. The third mode may be a power mode, applicable where a large amount of laundry or damp laundry needs to be treated. It is understood that the modes may be modified and varied appropriately depending on the user's needs or preferences.

Once the user selects a mode, a controller 80 (FIG. 2) controls the laundry treating machine 100 according to the selected mode. The controller 80 may execute commands stored in a memory 82, which cause the various components of the laundry treating machine 100 to operate in accordance with predefined instructions. For example, the operations of the first condensing device 22, the second condensing device 50, and the fan 32 may be controlled in accordance with the selected mode. In the exemplary embodiment, the first mode corresponds to the normal mode and the fan 32 may be operated at a predetermined normal rotational speed, regardless of noise generation. Then, the first condensing device 22, i.e. the heat pump, starts to operate and removes the moisture from the air to supply the dehumidified air to the accommodating space 12.

If the user selects the silent mode in the mode selecting step (S510), the controller 80 may control the fan 32 in a different manner. In the silent mode, the fan 32 will be operated at a rotational speed equal to approximately half the rotational speed of the normal mode. Further, the second condensing device 50 will be operated and the first condensing device 22 will be stopped or not initiated.

The second mode may correspond to the silent mode and may provide an option for the user that desires a quieter environment, without noise. This mode may be preferable, for example, where the user desires to read or sleep. During the silent mode, the fan 32 will generates less noise, but still function to force the air to flow from the accommodating space 12, through the heat pump 22, and out the opening 33.

It is preferable that the first condensing device 22 is stopped in the silent mode. If the first condensing device 22 is operated, the compressor 26 will also operate and generate some noise. Thus, instead of operating the first condensing device 22, the second condensing device 50 is operated in the silent mode. The configuration of the second condensing device is described above and the detailed description thereof will be omitted here.

Where the air is dried by the second condensing device 50 having the cooling fan 60 and the first heat exchanger 52, it is preferable that the cooling fan 60 (FIG. 4) is driven. The operation of the cooling fan 60 may generate some noise, however, the noise generated by cooling fan 60 is substantially less than the noise generated by fan 32, and is of such a level that it would not be unpleasant to the user.

Where the second condensing device 50 is used without the cooling fan 60, it is preferable that the circulation fan 34 is driven. While the circulation fan 34 is used largely to cool the compressor 26, it is noted the mechanism compartment 20 is compact and the circulation duct 29 and the second condensing device 50 are positioned near the compressor 26. As a result, driving the circulation fan 34 may promote the heat exchange performed at the second condensing device 50.

If the user selects the silent mode, the fan 32 is driven at half the rotational speed of the normal mode and dried air is supplied by the second condensing device 50 generating noticeably less noise. In this manner, the user may not be disturbed because of the noise.

In the meanwhile, if the user selects the third mode, that is, the power mode in the mode selecting step (S510), the controller 80 of the laundry treating machine rotates the fan 32 and drives both of the first and second condensing devices 22 and 50. in other words, the controller 80 drives all of the fan 32 and the first and second condensing devices 22 and 50.

The user selects the third mode, that is, the power mode when there is much laundry or much moisture on laundry. Thus, the controller 80 operates the first and second condensing devices 22 and 50 together to remove the much moisture of air and it drives the fan 32 at a normal rotational speed or higher.

In the power mode, there may be a large amount of laundry. As a result, both of the first and second condensing devices 22 and 50 may be driven to remove the moisture from the air regardless of the noise. During this mode, the fan 32 is driven at the rotational speed of the normal mode or higher. The process of driving the first and second condensing devices 22 and 50 is described above, thus a repeated description will be omitted.

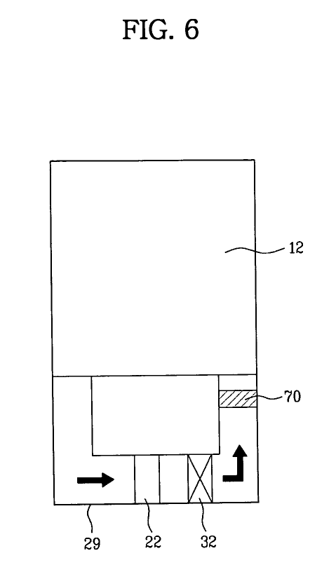

FIG. 6 is a diagram schematically illustrating a configuration of a laundry treating machine according to another embodiment of the present invention. Compared with the above embodiment, the laundry treating machine according to this exemplary embodiment includes identical elements except a heater replaces the second condensing device and the repeated description will be omitted. It is also noted that the first condensing device of the above embodiment is referenced to as a condensing device in this embodiment.

As illustrated in FIG. 6, the laundry treating machine according to this embodiment includes the accommodating space 12 for receiving laundry therein, the condensing device 22 for supplying dried air to the accommodating space 12, and a heater 70 heating the air circulated to the accommodating space 12 to increase dryness of the air, independent from the condensing device 22.

Here, the heater 70 forming the second condensing device may be provided along the circulation duct 29 and it is preferable that the heater 70 may be provided adjacent to an outlet through which air is flows from the circulation duct 29 to the accommodating space 12. This is because heating the dry air just before it flows into the accommodating space is advantageous in increasing the dryness of the air. The heater 70 may be any of a variety of heaters; however, it is preferable that the heater 70 is an electric heater. Further, it is preferable that the heater is of the type that generates little noise, thus it is preferable that the heater 70 is an electric heater.

A control method for the laundry treating machine having the above configuration may be similar to the control method described above.

The control method of the laundry treating machine according to this embodiment includes selecting a mode of the laundry treating machine and controlling operations of the condensing device 22, the heater 70, and the fan 32 in accordance with the selected mode. The second condensing device in the control method mentioned above is changed into the heater 70 and it is controlled in a similar order.

If the user selects the first mode, which in the exemplary embodiment is the normal mode, in the mode selecting step the controller 80 of the laundry treating machine drives the fan 32 and the condensing device 22. If the user selects the second mode, which in the exemplary embodiment is the silent mode, the controller 80 drives the heater and drives the fan 32 at half the rotational speed (or lower) of the normal mode. If the user selects the third mode, which in the exemplary embodiment is the power mode, the controller 80 drives the fan 32 together with the condensing device 22 and the heater 70. The detailed description of this operation is explained above, thus, the repeated description will be omitted.

The refresher type laundry machine, capable of supplying dried air, is presented as the laundry treating machine in the above exemplary embodiments of the invention. However, it is noted that the present invention may be applied a variety of laundry machine types and is not limited to the refresher. For example, the laundry treating machine may include a dryer and washing machine having a drying function capable of supplying dried air to laundry.

As mentioned above, the laundry treating machine according to the present invention includes the independent second condensing device and the moisture contained in the laundry may be removed with minimized noise. Furthermore, the laundry treating machine includes at least one mode which can be selected by the user which is a silent mode suppressing the noise generation. As a result, if the user selects the silent mode, the noise generation is minimized while the moisture contained in the laundry may still be removed.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A laundry treating machine comprising:
an accommodating space to receive laundry therein;
a circulation duct in communication with the accommodating space;
a first condensing device provided along the circulation duct to remove moisture from the air and supply dried air to the accommodating space; and
a second condensing device provided along the circulation duct to remove additional moisture from the dried air supplied to the accommodating space, the second condensing device being independent from the first condensing device.

2. The laundry treating machine of claim 1, wherein the first condensing device comprises a heat pump.

3. The laundry treating machine of claim 2, further comprising a fan blowing air along the circulation duct.

4. The laundry treating machine of claim 3, wherein the second condensing device comprises a heat exchanging unit to exchange heat with the air supplied to the accommodating space.

5. The laundry treating machine of claim 4, wherein the heat exchanging unit comprises at least one fin.

6. The laundry treating machine of claim 4, wherein the heat exchanging unit comprises a first heat exchanger provided at an outside of the circulation duct.

7. The laundry treating machine of claim 6, wherein the heat exchanging unit further comprises:
at least one of a second heat exchanger provided at an inside of the circulation duct; and
a cooler configured to cool the first heat exchanger.

8. The laundry treating machine of claim 7, wherein the cooler comprises a cooling fan.

9. The laundry treating machine according to claim 1, further comprising:
a steam generator supplying steam to the accommodating space.

10. A control method of a laundry treating machine comprising an accommodating space to receive laundry therein, a first condensing device to supply dried air to the accommodating space, and a second condensing device to increase dryness of the dried air, independent from the first condensing device, the method comprising:
selecting one of a first or a second mode of the laundry treating machine;
controlling the first condensing device and the second condensing device according to the selected mode;
driving the first condensing device when the first mode is selected; and
driving the second condensing device when the second mode is selected.

11. The control method of claim 10, further comprising:
controlling a fan to circulate the dried air if the first condensing device or the second condensing device is driven.

12. The control method of claim 11, further comprising:
driving the fan at a first rotational speed when the first mode is selected; and
driving the fan at half the rotational speed of the first mode when the second mode is selected.

13. The control method of claim 11, wherein the laundry treating machine further comprises a third mode, the control method further comprising:
driving the fan and the first and second condensing devices at the same time when the third mode is selected.

14. The control method of claim 11, further comprising:
driving a cooler to cool the second condensing device if the second condensing device is driven.

15. The control method of claim 11, wherein the first condensing device comprises a heat pump, the heat pump including an evaporator, a compressor, and a condenser, the laundry treating device further comprising a circulation fan to cool the compressor, the control method further comprising:
driving the circulation fan if the second condensing device is driven.

16. A laundry treating machine comprising:
an accommodating space to receive laundry therein;
a circulation duct in communication with the accommodating space;
a condensing device provided along the circulation duct to supply dried air to the accommodating space; and
a heater provided along the circulation duct to heat the dried air and remove additional moisture from the dried air before the dried air is supplied to the accommodating space, the heater being independent from the first condensing device.

17. The laundry treating machine of claim 16, wherein the heater is provided adjacent to an outlet through which dried air is supplied to the accommodating space.

18. A control method of a laundry treating machine comprising and accommodating space to receive laundry therein, a condensing device to supply dried air to the accommodating space, and a heater configured to heat the dried air, the heater being independent from the first condensing device, the control method comprising:
selecting one of a first mode or a second mode of the laundry treating machine;
controlling the condensing device and the heater according to the selected mode;
driving the condensing device when the first mode is selected; and
driving the heater when the second mode is selected.

19. The control method of claim 18, further comprising:
driving a fan to circulate the dried air when either the condensing device or the heater is driven.

20. The control method of claim 19, further comprising:
driving the fan at a first rotational speed when the first mode is selected; and
driving the fan at half the rotational speed of the first mode when the second mode is selected.

21. The control method of claim 19, wherein the laundry treating machine further comprises a third mode, the control method further comprising:
driving the fan, the condensing device, and the heater at the same time when the third mode is selected.
